(19) United States
(12) Patent Application Publication
(10) Pub. No.: US 2015/0187329 A1
(43) Pub. Date: Jul. 2, 2015

(54) METHOD AND SYSTEM FOR IMPLEMENTING FLEXIBLE COLOR SCHEMES IN A RASTER IMAGE

(71) Applicant: GroupeSTAHL, St. Clair Shores, MI (US)

(72) Inventor: Fred Ciaramitaro, St. Clair Shores, MI (US)

(73) Assignee: GroupeSTAHL, St. Clair Shores, MI (US)

(21) Appl. No.: 14/146,417

(22) Filed: Jan. 2, 2014

(51) Int. Cl. G09G 5/06; H04N 1/60

(52) U.S. Cl. CPC G09G 5/06; H04N 1/60

(57) ABSTRACT

A method for coloring a greyscale raster image defined by a plurality of predefined greyscale values, having the following steps: (i) receiving a color selection intended for a portion of the raster image; (ii) retrieving from a predefined database multiple groups of predefined color parameter values, each group of predefined color parameter values defining a color parameter associated with the selected color, and each group of predefined color parameter values including a predefined greyscale value; and (iii) for each pixel within said portion of said raster image, determining a pixel channel value for each of a plurality of color channels that collectively define an appearance of said pixel, said determination being based on said predefined greyscale value for said pixel, and said predefined color parameter values for at least two of said predefined color parameters associated with said selected color.

### BACKGROUND

In the graphic art field, there is often a need to change the color of a raster image or graphic that was created and stored on a computer. This need to make color changes can occur for a variety of types of images—whether they are ultimately intended to be displayed on a computer display or monitor, paper, apparel or some other medium—including clip art, computer illustrations, photography, transfer graphics for apparel, and many other such images. For example, it is common for Internet websites offering products for sale, such as automobiles and apparel for example, to allow a user to change the color of a selected product in real time in order to view the same product in different colors. Another example occurs in the field of graphic art used for transfers to apparel, wherein it may be desirable to easily produce the same graphic in different colors. Additionally, users may desire to have flexibility to modify the color of various portions of a given image or graphic. An example of this may be an image of a cowboy where his hat, shirt, kerchief, pants and boots are all different colors from each other. A designer may wish to change the cowboy's shirt color from blue to yellow, while leaving the rest of the image intact.

One known method for changing the color of all or part of an existing image or graphic is known as the “Hue Shift” method. When the Hue Shift method is used, the designer originally colors the various portions of the image (during the design process) using the HSB (Hue, Saturation, Brightness) color model, wherein the “hue,” “saturation,” and “brightness” are three “channels” used to define the color and appearance of each pixel in an image. Each pixel is defined by a value for each of the three HSB channels. This method is well known to those skilled in the art. According to this method, the designer colors a portion of an image having a particular color using a single hue value. For example, building on the example of the cowboy image mentioned above, if the cowboy's shirt in the original design is blue, then the designer would color the cowboy's shirt using a single hue value corresponding to blue for each of the pixels in the shirt. Then, the designer would create various shades and highlights in the cowboy's blue shirt by adjusting the saturation and brightness channels of each pixel of the shirt. The combination of the blue hue and the values applied in the saturation and brightness channels in each of the pixels gives the cowboy's shirt its overall appearance, including color and highlights and shading.

After the image is designed with an original set of colors for each particular region of the image, the colors can be changed by simply changing the value of the hue channel. For example, the hue channel could be changed from a blue value to a yellow value. The values of the saturation and brightness channels would remain the same, which conceptually should maintain the same highlighting and shading in the image. However, this approach has several shortcomings. First, values in the saturation and brightness channels affect the appearance differently depending on the value in the hue channel. For example, in the HSB color model, darker shades of a particular color are created by reducing the value of the brightness channel, which essentially introduces a certain amount of black into the color. While this approach is effective for darker colors, it tends to make lighter colors look dingy or “muddy.” On the other hand, lighter shades of a particular color are created by increasing the value of the brightness channel, which introduces white into the color. This approach is effective for lighter colors, but tends to make darker colors look flat or “milky.” Another shortcoming of the Hue Shift method is that is can only be used in connection with images created using the HSB color model, whereas the CMYK (Cyan, Yellow, Magenta, Black) color model is commonly used in various applications, such as printing. Finally, the HSB model requires that images be colored with starting color values during the design process. The values chosen by the designer for a particular color will depend on the intended color management/printing workflow variables, such as color profiles, printer selection, ink selection and media selection. If any of these variables change in the future, the original HSB design will look different unless the HSB values are manually adjusted in the image file, which effectively requires that the image be re-created by a designer.

Another method for changing the color of an image/graphic is the “Swap Image” method, wherein a designer creates several versions of the same graphic or image, each with different colors. Then, when a user wants to change the color of the all or part of the graphic/image, the original image/graphic is simply swapped out for a different pre-colored image/graphic having the same design but different colors. Essentially, the designer must create a different version of the same image/graphic for each color option that is made available to a user. As a result, this method is very time consuming and overhead intensive. Therefore, though this method enables better color reproduction for the various options available to a user, the color options are more likely to be restricted because of the substantial work required to produce a separate and distinct graphic/image for each color option.

The inventor hereof has developed an improved system and method for changing the color of an image/graphic created and stored on a computer.

### SUMMARY

A method for coloring a greyscale raster image is disclosed. The greyscale raster image is defined by a plurality of predefined greyscale values. The method of coloring the greyscale raster image includes the steps of: (i) receiving a color selection intended for a portion of the raster image; (ii) retrieving from a predefined database multiple groups of predefined color parameter values, each group of predefined color parameter values defining a color parameter associated with the selected color, and each group of predefined color parameter values including a predefined greyscale value; and (iii) for each pixel within said portion of said raster image, determining a pixel channel value for each of a plurality of color channels that collectively define an appearance of said pixel, said determination being based on said predefined greyscale value for said pixel, and said predefined color parameter values for at least two of said predefined color parameters associated with said selected color.

### DRAWINGS

The drawings described herein are for illustrative purposes only of selected embodiments and not all possible implementations, and are not intended to limit the scope of the present disclosure.

FIG. 1 is an illustration of a generic computer and printer arrangement, which is an exemplary environment in which the embodiments described herein may be used.

FIG. 2 is an illustration of a portion of a raster image defined by a plurality of pixels;

FIG. 3 is an illustration of an exemplary color engine database, having predefined color parameter values for each of three exemplary color parameters, i.e., Lightest Tone, Mid Tone and Darkest Tone.

FIG. 4 is a flowchart illustrating steps of an exemplary method for coloring a greyscale raster image.

Corresponding reference numerals indicate corresponding parts throughout the several views of the drawings.

### DETAILED DESCRIPTION

A system and method is described for changing the color of at least a portion of raster image. The system and method starts with a greyscale CMYK (Cyan, Magenta, Yellow, Black) format raster image originally created by a designer as a “base” image. The greyscale base image may be colored in real time by calculating CMYK values for each pixel in the image or selected portion of the image based on (i) the desired color chosen by a user; (ii) CMYK values for multiple color parameters retrieved from a database corresponding to the desired color; and (iii) the K value—the degree of grey—of the pixel in the base image. The CMYK values for the pixel are calculated by interpolation between the predefined CMYK values (stored in the database) for two of the color parameters. The color parameters may be the Lightest Tone, the Mid Tone and the Darkest Tone for a particular color.

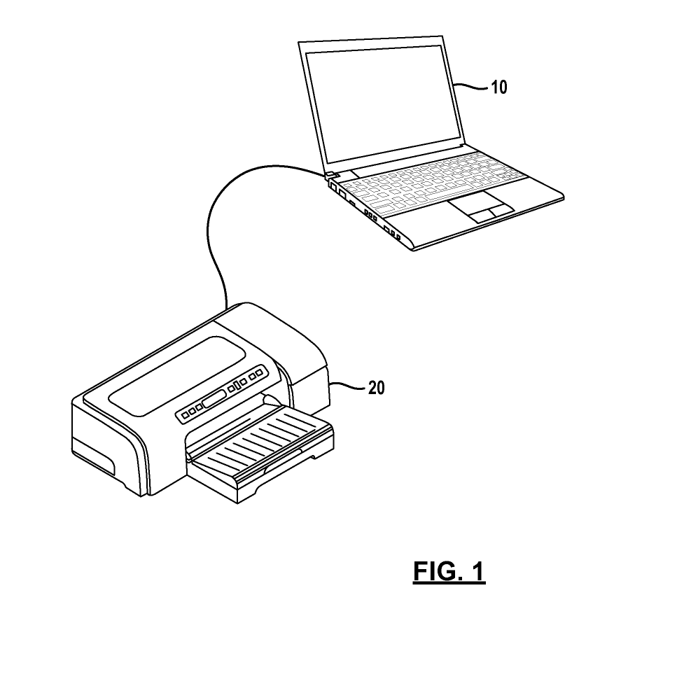

FIG. 1 illustrates a well-known arrangement of a computer 10 in communication with a printer 20. The embodiments of the system and method for coloring an image can be used in connection with various types of computers, including personal computers, laptop computers and other types of computers that are able to store and process image files. The embodiments described herein may be used in connection with images that are intended to be printed on a physical medium, such as paper or apparel, as well as displayed on a computer monitor.

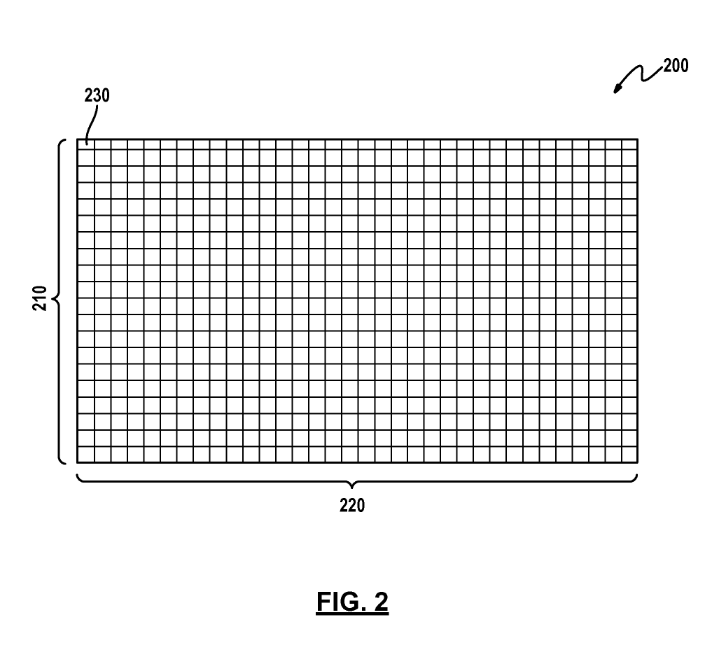

The embodiments described herein involve coloring computer images known as “raster images.” A raster image—also known as a bitmap—is an image formed by a collection of pixels, or points of color, which are normally arranged in a rectangular format. FIG. 2 illustrates an amplified portion of a raster image showing individual pixels 230 arranged in rows 210 and columns 220. A single image, depending on its size and resolution, can be comprised of many millions of pixels. Raster images are normally stored in an image file on a computer storage medium. Raster images can be displayed on a display device, such as a computer monitor, and/or printed on various physical mediums, such as paper and apparel.

In a raster image, the color of each pixel is defined by various values according to a standard color format. The CMYK (Cyan, Magenta, Yellow, Black) format is a commonly-used format for defining the color of each pixel of a raster image. Under the CMYK format, the color of each pixel is defined by a blend of different amounts of cyan, magenta, yellow and black, each of which is referred to as a “channel.” Thus, each pixel 230 is defined by four values—one for each of the C, M, Y, and K channels—each of which being between 0 and 100 and defining how much of the respective C, M, Y and K components to blend into the color for that particular pixel 230 to achieve the precise desired color.

The disclosed system and method starts with a base raster image that is created by an artist/designer in a greyscale CMYK (Cyan, Magenta, Yellow, Black) format. The greyscale CMYK base image usages only the K (black) channel. That is, the C, M and Y channels of each pixel of the base image are set to zero and each pixel is defined only by a K value, which essentially represents the amount of black that is in the pixel. As a result, the base image created by the designer is a “black and white” image, where each pixel is either all black (K=100), all white (K=0) or a shade of grey (100>K>0). The various levels of grey are used to create shading and highlighting in the image. After the base greyscale image has been created, it can be colorized in real time based on user selections for color. The image can be colorized by the designer or it can be colorized by a user of a computer program, such as in connection with the Website, to colorize the image in real time. The steps associated with coloring the greyscale raster image are executed by at least one computing device having non-transitory computer-readable storage medium with an executable program stored thereon to execute the steps, as described hereinbelow.

The coloration of the base image is accomplished by first receiving a chosen color for all or a portion of the image. For example, again building on the cowboy image example described above, a user may desire to color the cowboy's kerchief “red.” In this case, the pixels in the image that define the cowboy's kerchief will need to be colored “red,” but each pixel is likely to have a slightly different shade of red due to the highlighting and shadowing in the base image. Therefore, a value (e.g., between 0 and 100) must be calculated for each of the Cyan, Yellow, Magenta and Black channels for each pixel of the cowboy's kerchief. Those values are calculated by using the K-channel value of the base image to index into a database—referred to herein as a “color engine database”—and to interpolate values for each of the CMYK channels for each pixel based on the predefined CMYK values of at least two color parameters for each color. In one embodiment, the color engine database includes three color parameters for each color, namely a “Lightest Tone,” a “Mid Tone,” and a “Darkest Tone.” Collectively, the Lightest Tone, Mid Tone and Darkest Tone are referred to herein as the “color parameters.” Different numbers of color parameters may be employed as well. The color engine database stores predefined values (i.e., “color parameter values”) for the CMYK channels for the Lightest Tone, Middle Tone and Darkest Tone of each available color.

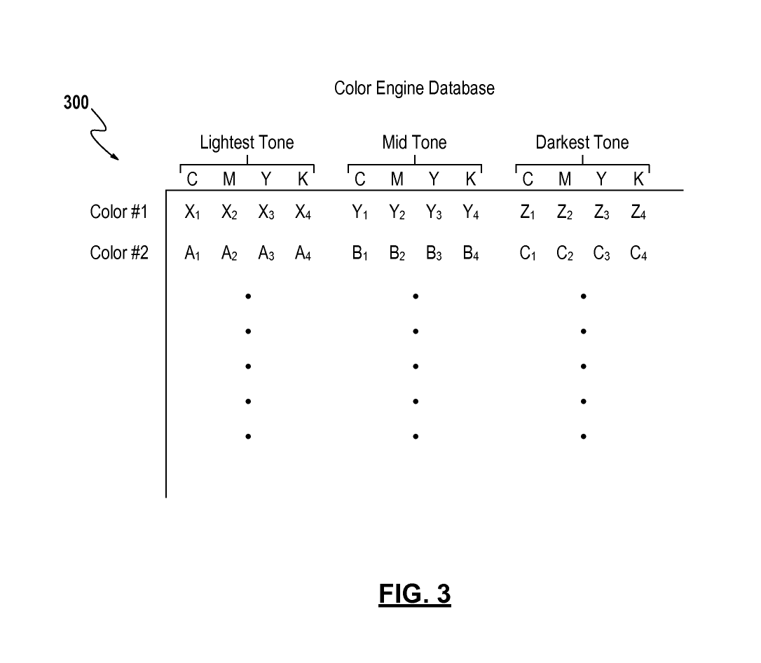

FIG. 3 is an illustration of a portion of an exemplary color engine database according to one embodiment. The color engine database 300 includes data that defines color parameters for each color that is made available to a user. FIG. 3 illustrates the various colors as “Color #1,” “Color #2,” and so on. Each color is associated with a set of color parameters, shown in FIG. 3 as a Lightest Tone, a Mid Tone, and a Darkest Tone. The Lightest Tone and the Darkest Tone define the full range of shades of the associated color, and the Mid Tone is the midpoint between the Lightest Tone and the Darkest Tone. The Lightest Tone, Mid Tone and Darkest Tone correspond to nominal values, such as 0 for the Lightest Tone, 50 for the Mid Tone and 100 for the Darkest Tone.

Each of the Lightest Tone, Mid Tone and Darkest Tone are associated with CMYK values, one value (ranging from 0 to 100) for each of the CMYK channels. Accordingly, in the illustrated embodiment having three color parameters, each color in the color engine database is associated with 12 values (e.g., between 0 and 100), i.e., four for each CMYK parameter. For example, “Color #1” in FIG. 3 is associated with values X₁-X₄ for the CMYK values for the Lightest Tone parameter; with values Y₁-Y₄ for the CMYK values for the Mid Tone Parameter; and with Z₁-Z₄ for the CMYK values for the Darkest Tone. The number of colors that can be included in the color engine database 300 is unlimited. The CMYK values for each of the color parameters (e.g., Lightest Tone, Mid Tone, and Darkest Tone) are specified by the designer and may be, for example, values between 0 and 100.

The CMYK values for each pixel in the image (referred to individually as a “calculated pixel”) are calculated as follows. The color chosen by the user is located in the database. Then, the K value of the calculated pixel of the base image is assessed to determine if it corresponds to the Lightest Tone, the Mid Tone or the Darkest Tone. In the embodiment where the K values of the base image can range from 0 to 100, this is accomplished by determining if the K value of the calculated pixel of the base image is 0 (corresponding to the Lightest Tone), 50 (corresponding to the Mid Tone) or 100 (corresponding to the Darkest Tone). If the K value of the calculated pixel of the base image corresponds to one of the Lightest Tone, the Mid Tone or the Darkest Tone, then the CMYK values from the color engine database corresponding to the Lightest Tone, the Mid Tone or the Darkest Tone, as applicable, are assigned to the calculated pixel. For example, with reference to FIG. 3, and assuming that the K values of the base image range from 0 to 100 (0=Lightest Tone; 50=Mid Tone; 100=Darkest Tone), if the K value of the calculated pixel of the base image equals 0 (Lightest Tone), then the CMYK values to implement the chosen color will be X₁, X₂, X₃, X₄, respectively (i.e., C=X₁, Y=X₂, M=X₃, and K=X₄). Similarly, if the K value of the calculated pixel of the base image equals 50 (Mid Tone) or 100 (Darkest Tone), then the CMYK values used to implement the chosen color will be Y₁-Y₄ or Z₁-Z₄, respectively.

If, as in most cases, the K value of the calculated pixel of the base image does not exactly equal 0 (Lightest Tone), 50 (Mid Tone) or 100 (Darkest Tone), then the proper CMYK values for the calculated pixel are calculated by interpolation between the closest two color parameters, e.g., between the Lightest Tone and the Mid Tone or between the Mid Tone and the Darkest Tone. For example, again referring to FIG. 3, if the K value of the calculated pixel of the base image is greater than 0 (Lightest Tone) and less than 50 (Mid Tone), then the CMYK value of the calculated pixel is calculated by interpolating between the CMYK values of the Lightest Tone and the Mid Tone. Similarly, if the K value of the calculated pixel for the base image is greater than 50 (Mid Tone) and less than 100 (Darkest Tone), then the CMYK value of the calculated pixel is calculated by interpolating between the CMYK values of the Mid Tone and the Darkest Tone. A person skilled in the art understands various methods of interpolation, and one such method is illustrated below.

In one embodiment, with reference the example of FIG. 3, an interpolation factor is calculated according to the following formula: A=(Z_{B}−Z_{lower})/(Zᵤₚₚₑᵣ−Z_{lower}), where Z_{B} is the Z value of the calculated pixel of the base image; Zᵤₚₚₑᵣ is either 100 (Darkest Tone) or 50 (Mid Tone), depending on whether Z_{B} is greater than or less than 50 (Mid Tone). Z_{lower} is either 50 (Mid Tone) or 0 (Lightest Tone), depending on whether ZB is greater or less than 50 (Mid Tone). Then, the CMYK values for the calculated pixel are calculated according to the following formulas: (i) If Z_{B}<50 (Mid Tone), then C=X₁+(A*(Y₁−X₁)), M=X₂+(A*(Y₂−X₂)), Y=X₃+(A*(Y₃−X₃)), K=X₄+(A*(Y₄−X₄)); and (ii) If Z_{B}>50 (Mid Tone), then C=Y₁+(A*(Z₁−Y₁)), M=Y₂+(A*(Z₂−Y₂)), Y=Y₃+(A*(Z₃−Y₃)), K=Z₄+(A*(Z₄−Y₄)). By way of example, if the base K value for a calculated pixel in the cowboy's kerchief (in the example above) is 75, then the interpolation factor A would be 0.5 (calculated as (75−50)/(100−50)). If the cowboy's kerchief in the above example is chosen to be “red,” and “red” is “Color #1” in FIG. 3, then the CMYK values for the calculated pixel would be calculated according to the following formulas: C=Y₁+0.5*(Z₁−Y₁); M=Y₂+0.5*(Z₂−Y₂); Y=Z₃+0.5*(Z₃−Y₃); K=Z₄+0.5*(Z₄−Y₄). This approach is repeated for each pixel in the cowboy's kerchief.

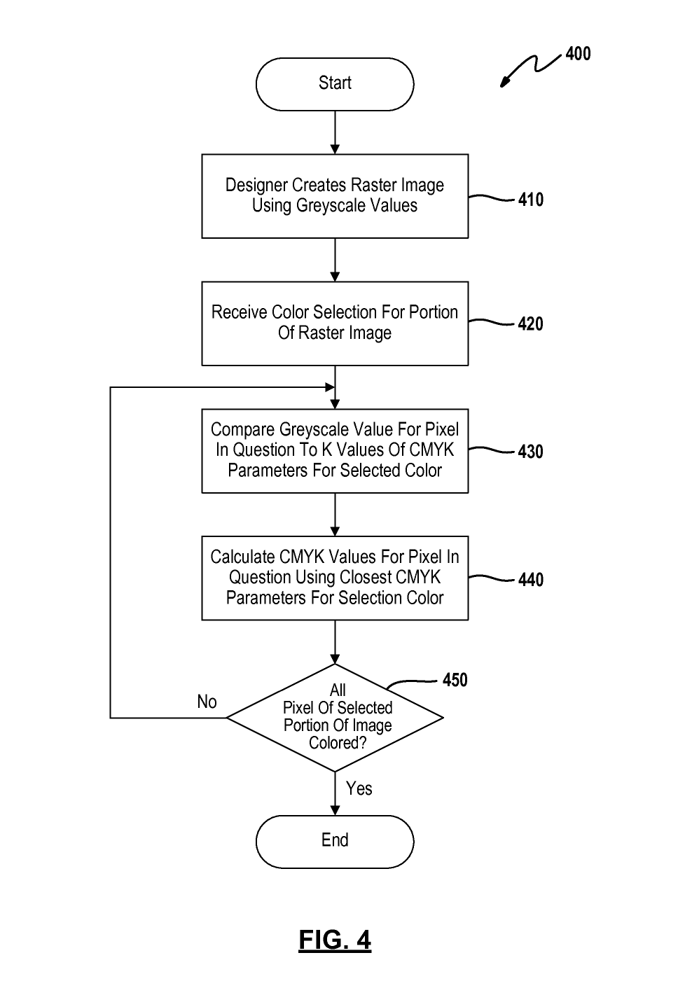

FIG. 4 is a flow diagram that graphically illustrates the steps of the method 400 for changing colors in a raster image. First, at step 410, a raster image is created by a designer using a single channel to define each pixel of the image in greyscale. For example, in the CMYK color format, the raster image is created by the designer using only the K channel. In one embodiment, the range of K values is from 0 to 100. Steps 420-450 set out the steps involved in selectively colorizing the greyscale raster image created by the designer in step 410. The steps at 420-450 may be implemented in computer code that is stored on a computer readable medium, such as a hard disk and solid state drive and executed by a processor in the computer. In step 420, a color selection for a portion of the raster image is received. The color selection may be made by a user of the system, such as a designer or an end user of a website or application program. The color selection may be provided to a computer executing the described steps through an input device, such as a keyboard, mouse or touchscreen. At steps 430-440, the selected color is used along with the color engine database to calculate CMYK values for each pixel to be colored within the selected portion of the raster image. At step 430, it is determined if the K value (greyscale value) of the base image for a calculated pixel is equal to 0 (Lightest Tone), 50 (Mid Tone) or 100 (Darkest Tone). If so, then (at step 440) the CMYK values that correspond to the Lightest Tone, Mid Tone or Darkest Tone (as applicable) for the selected color are assigned to the calculated pixel. For example, if the K value of a calculated pixel equals 0 (Mid Tone), then the CMYK values for the calculated pixel are set to the CMYK values of the Mid Tone in the color engine database for the selected color. If, as in most cases, the base K value falls between the K values for two color parameters (e.g., between 0 (Lightest Tone) and 50 (Mid Tone) or between 50 (Mid Tone) and 100 (Darkest Tone), then the CMYK values for the calculated pixel are calculated at step 450. The CMYK values are calculated by interpolation, using the values of the two color parameters that bound the base K value of the calculated pixel along with the base K value itself. This process is used to calculate the CMYK values for each pixel within the selected area, until all such pixels have been colorized. After all of the pixels in the selected area have been colorized (step 450), the process ends.

The system and method described above has various benefits. For example, the method described above allows a designer to independently specify CMYK values for the color parameters, such as Lightest Tone, Mid Tone, and Darkest Tone, which allows the designer better flexibility to create consistent shading and highlighting patterns, regardless of the selected color. Further, because the color engine database is separate from the image itself, the designer need only create the base image once. Yet, the color engine database can be easily updated and revised without the need to modify the base image. Further, different color engine databases can be selectively used with the same base image, which may sometimes be important due to the fact that there are variations in the way different printers print images on different types of media. The ability to match different color engine databases with different printers allows a designer to ensure consistent appearance of the image, regardless of the selected color(s) and regardless of the selected printer. Finally, the method described herein can be used with known graphic design features, such as the use of multiple layers within the same design and the use of transparent image layers of 256 different degrees of transparency.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for coloring a greyscale raster image defined by a plurality of predefined greyscale values, said method being implemented on at least one computing device having non-transitory computer-readable storage medium with an executable program stored thereon, said method comprising the steps of:
executing the program stored on the computer-readable storage medium, wherein the program instructs the at least one computing device to:
receive a color selection intended for a portion of the raster image;
retrieve from a predefined database multiple groups of predefined color parameter values, each group of predefined color parameter values defining a color parameter associated with the selected color;
for each pixel within said portion of said raster image, determine a pixel channel value for each of a plurality of color channels that collectively define a color of said pixel, said determination being based on said predefined greyscale value for said pixel, and said predefined color parameter values for at least two of said predefined color parameters associated with said selected color.

2. The method of claim 1, wherein said color parameters include a Lightest Tone, a Mid Tone, and a Darkest Tone.

3. The method of claim 2, wherein said step of determining a pixel channel value for each of a plurality of color channels comprises interpolating a value for each color channel based on said values of corresponding channels for one of: (i) the group of the Lightest Tone and the Mid Tone; and (ii) the Mid Tone and the Darkest Tone.

4. The method of claim 1, wherein each pixel within said raster image is defined by a four channel CMYK color format.

5. The method of claim 1, wherein each group of predefined color parameter values includes four separate values that each correspond to one of the channels in a CMYK color format.

6. The method of claim 1, wherein said step of determining a pixel channel value for each of a plurality of color channels comprises interpolating a value for each color channel based on said values of corresponding color channels for two of said color parameters.

7. The method of claim 1, wherein said step of determining a pixel channel value for each of a plurality of color channels comprises calculating a value for each color channel based on said values of corresponding color channels for two of said color parameters.

8. The method of claim 1, wherein said step of receiving a color selection comprises receiving said color selection from a user of a computer.

9. A method for coloring a greyscale raster image defined by a plurality of predefined greyscale values, said method being implemented on at least one computing device having non-transitory computer-readable storage medium with an executable program stored thereon, said method comprising the steps of:
executing the program stored on the computer-readable storage medium, wherein the program instructs the at least one computing device to:
receive from a user a color selection intended for a portion of the raster image;
retrieve from a predefined database multiple groups of predefined CMYK values, each group of predefined CMYK values defining a color parameter associated with the selected color;
calculate a group of CMYK values for a pixel within said portion of the raster image by interpolation based on said greyscale value for said pixel and said predefined CMYK values for at least two of said predefined color parameters associated with said selected color.

10. The method of claim 9, wherein said color parameters include a Lightest Tone, a Mid Tone, and a Darkest Tone.

11. The method of claim 9, wherein each group of predefined CMYK values includes a value for each of the C, M, Y and K channels of a CMYK color format.

12. The method of claim 9, wherein said step of calculating a group of CMYK values is repeated for each pixel within said portion of said raster image.
